(19) United States
(12) Patent Application Publication
(10) Pub. No.: US 2026/0334487 A1
(43) Pub. Date: Oct. 29, 2026

(54) GEL BASED FORMULATION FOR ENHANCING SHELF LIFE OF AGRICULTURAL PRODUCTS AND METHOD FOR PREPARATION THEREOF

(71) Applicant: FRUVETECH PRIVATE LIMITED, N Delhi (IN)

(72) Inventors: Aprajita KUMARI, New Delhi (IN); Vithal Kumar LAKKINENI, Telangana (IN); Surya PRAKASH, Patna (IN)

(73) Assignee: FRUVETECH PRIVATE LIMITED, N Delhi (IN)

(21) Appl. No.: 19/106,153

(22) PCT Filed: Aug. 24, 2023
(86) PCT No.: PCT/IN2023/050800

§ 371 Date: Feb. 24, 2025

(30) Foreign Application Priority Data
Aug. 25, 2022 (IN) 202211048569

(51) Int. Cl. A23B 7/154

(52) U.S. Cl. CPC A23B 7/154

(57) ABSTRACT

The present invention relates to a gel based formulation for enhancing shelf life of agricultural products and a method for preparation thereof. The method for preparing gel based formulation is based on natural route which results in the preparation of organic gel based formulation. The method employs the use of peels of fresh citrus fruits serving as a natural source of ascorbate. The gel based formulation of the present invention may also be prepared through synthetic route. The gel based formulations prepared in the present invention generates nitric oxide which ultimately increases the shelf life of agricultural products.

### FIELD OF INVENTION

The present invention relates to a gel based formulation for enhancing shelf life of agricultural products and a method for preparation thereof. More particularly, the present invention relates to a gel based formulation that generates nitric oxide gas which inhibits ethylene production and ultimately results in enhancing shelf life of agricultural products like fruits and vegetables and prevents spoilage thereof.

### BACKGROUND OF THE INVENTION

Fruit and vegetables are essential source of nutrition. They contain a number of vitamins and minerals that are essential for well-being of human beings. The vitamins includes vitamins A (beta-carotene), vitamin E, and vitamin C. The minerals include zinc, magnesium, folic acid, and phosphorous. Such elements play an essential oil in maintaining good health. For instance, folic acid reduces blood level of homocysteine which is a major compound responsible for coronary heart disease. Fruits and vegetables also contain low content of salt, fat, and sugar and are also a source of dietary fibers. Fruits and Vegetables also contain phytochemicals which are biologically active compounds capable of preventing a number of diseases in human beings.

Nowadays, fruits and vegetables are prone to spoilage in absence of proper measures. Therefore, it is essential to take proper measures so as to ensure enhanced shelf life of fruits and vegetables. When the fruits and vegetables are supplied to consumers majorly as peeled or in slices, some adverse conditions may take place like alteration in taste and color of fleshy portions of fruits or vegetables as well as change in shape and structure of such products. Furthermore, the antimicrobial substances employed as coating for improving shelf life of fruits and vegetables makes the direct consumptions of such products impossible and such substances need to be removed before consuming such products. Furthermore, such fruits and vegetables need be stored at a desired temperature so as to enhance shelf life of such products. Generally, storing fruits and vegetables at low temperature slows down the rate of respiration along with ripening process and senescence process which ultimately results in prolonged shelf life of fruits and vegetables. Such low temperatures also slows down the growth of the pathogenic fungi responsible for spoilage of fruits and vegetables during storage. Further, temperature that are too low may also be harmful for fruits and vegetables as such temperature may result in chilling injury, and subsequently prone to spoilage fruits and vegetables. Further, certain kind of fruits such as mangoes, banana, custard apple, plums and guava cannot be stored in refrigerator as it may affect the quality and texture of the fruits. Moreover, refrigeration is not cost-effective and farmers may not be able to afford to have refrigeration technology for storage of fruits and vegetables.

One of the major reasons for spoilage of fruits and vegetables includes natural ripening process accompanied by increase in respiration and ethylene production. As the fruits and/or vegetable ripens, such products become soft and may easily be bruised. In most of the cases, such products become soft and susceptible to mechanical injury as well as microbial infections. The fruits that are completely ripened are prone to several diseases and/or other agents responsible for spoilage due to decreased defense responses and enhanced level of sugar. Ethylene is gaseous plant hormone which is directly involved in promotion of the ripening process of variety of fruits and vegetables at all stages. As ethylene plays an essential role in ripening process of fruits and vegetables, the alteration of ethylene biosynthesis/signaling as well as the quantity of production is one of the means to slow down the natural ripening process of fruits and vegetables. Further, regulation of respiration of fruit and/or vegetable respiration also serve as an essential way to slow down ripening.

There are several cellular signals that regulate ethylene production and perception thereof in various organs of plants. Among such signaling molecules, the participation of Gaseous free radical Nitric Oxide (‘NO’) signal has to be known to one of the major molecule involved in regulation of ethylene. Nitric Oxide interferes with ethylene biosynthetic pathway and directly affects and influence fruit ripening. In addition to regulating ethylene production, Nitric Oxide induces plant defense responses via salicylic mediated pathway and slowdowns the respiration. Nitric Oxide-generated signals transcriptionally antagonize ethylene pathway, thereby causing post-climacteric biochemical changes which are linked to fruit quality by the following modes including (a) Nitric Oxide negatively regulates the expression of ethylene biosynthetic genes 1-Aminocycopropane 1-carboxylic acid oxidase (ACO) genes ACO1, AC0H2 and AC04; (b) Nitric Oxide causes post translational modifications such as nitrosylation of ethylene biosynthetic enzymes such as Methionine Adenosyltransferase (MAT); (c) Nitric Oxide reacts with ACC oxidase form a binary ACC oxidase-and this complex formation eventually leads to its inhibition; and (d) Nitric Oxide induces plant defense responses.

The conventional method for enhancing shelf life of agricultural products like fruits and vegetables involves coating the agricultural products with solutions/formulations. However, consumers acceptable of coating of fruits and vegetables if low. Furthermore, some of the coatings may not be safe when ingested. Furthermore, some of the coating may not offer fruits and vegetables in ready to eat form. Furthermore, some of the edible coating also exhibits disadvantages when applied over fruits such as the coating prepared from protein and polysaccharide shows poor water vapor barrier functions whereas wax and lipids shows weak mechanical characteristics. Further, Coating fruits is not an cost effective process.

There are several patent applications that provide a method for enhancing shelf life of fruits and vegetables. On such Chinese Patent Application CN 101669541 relates to a method for extending the fresh-keeping time of litchi fruits after harvest. The cited prior art discloses a mixture comprising of chitosan, and a fungicide for enhancing shelf life of Litchi postharvest. However, the fungicides when coated on the Litchi may form a film layer on the said fruit due to which Litchi cannot be sold in a ready-to-eat form due to adverse effects of fungicide.

Therefore, in order to overcome the problems associated with existing state of art, there is a need to develop a safe, contact-less, effective formulations for enhancing shelf life of agricultural products.

### OBJECTIVE OF THE INVENTION

The primary objective of the present invention is to provide a gel based formulation for enhancing shelf life of agricultural products and a method for preparation thereof.

Another objective of the present invention is to provide a gel based formulation inducing the production of nitric oxide gas which inhibits ethylene production and ultimately results in enhancing shelf life of agricultural products such as fruits and vegetables and prevents spoilage thereof.

Another objective of the present invention is to provide enhanced fruit defense against various pathogens during post-harvest storage.

Another objective of the present invention is to retain freshness and nutrient levels during post-harvest storage.

Yet another objective of the present invention is to regulate respiration by nitric oxide production during post-harvest storage.

Other objects and advantages of the present invention will become apparent from the following description taken in connection with the accompanying drawings, wherein, by way of illustration and example, the aspects of the present invention are disclosed.

### BRIEF DESCRIPTION OF DRAWINGS

An understanding of the present invention may be obtained by reference to the accompanying drawings, when taken in conjunction with the description herein and in which:

FIG. 1(a) illustrates a diagram depicting preparation of nitric oxide releasing beads;

FIG. 1(b) illustrates a diagram depicting of filtration of beads;

FIG. 1(c) illustrates a diagram depicting draining of beads to remove excess of water;

FIG. 1(d) and FIG. 1(e) illustrates a diagram depicting glass vials harbouring the beads;

FIG. 2(a) illustrates a diagram depicting nitric oxide releasing beads;

FIG. 2(b) illustrates dried nitric oxide releasing beads;

FIG. 2(c) illustrates a diagram depicting dried beads soaked in water;

FIG. 2(d) illustrates a diagram depicting re-constitution of beads;

FIG. 2(e) illustrates beads containing core filled with solution;

FIG. 3 illustrates a diagram depicting organic formulation nitric oxide releasing gel;

FIG. 4 illustrates a diagram depicting release of nitric oxide from gel based formulations;

FIG. 5 illustrates effect of gel based formulation on shelf life of Alphanso mangoes;

FIG. 6 illustrates effect of gel based formulation on shelf life of Dinga mangoes;

FIG. 7 illustrates effect of gel based formulation on shelf life of Ritol mangoes;

FIG. 8 illustrates effect of gel based formulation on shelf life of Blueberry;

FIG. 9 illustrates effect of gel based formulation on shelf life of Banana;

FIG. 10A illustrates effect of gel based formulation on respiratory rate of custard Apple; and

FIG. 10B illustrates effect of gel based formulation on respiratory rate of banana.

### SUMMARY OF THE INVENTION

The present invention relates to a gel based formulation that generates nitric oxide gas which inhibits ethylene production and ultimately results in enhancing shelf life of agricultural products like fruits and vegetables and prevents spoilage thereof. The method for preparing gel based formulation is based on natural route. The method comprises of (a) drying peels of citrus fruits in a dryer at 70-72 °C for at least 3 days; (b) grinding the peels into fine powder; (c) treating nitrate nutrition grown hydroponic (8-10 week old plants) plants with oxygen concentration of 0.5% to 4% under dark and red light cycles (60-100 pmol nrs s~; of red light) for 12-18 hours at 18-22 degrees, subsequently drying whole plant at 60-70 °C for 24 hours and grinding to fine powder in the presence of citrus peel powder (as ascorbate source); (d) adding 1.5-2% solidifying agent in 200-250 ml of distilled water; (e) heating the solution prepared in step (d) for 1-2 minutes; (e) adding 3-5% of powder of citrus peels prepared in step (d); (f) adding 3-15% of vinegar to the solution obtained in step (e); and (f) adding 0.5-8% of acidified cumin powder to the solution obtained in step (e), forming gel based formulation. The gel based formulation of the present invention may also be prepared through synthetic route.

### DETAILED DESCRIPTION OF THE PRESENT INVENTION

Before the present composition and method are described, it is to be understood that this disclosure is not limited to a particular composition and method as described, as there can be multiple possible embodiments that are not expressly illustrated in the present disclosure but may still be practicable within the scope of the present disclosure.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

Accordingly, those of ordinary skill in the art will recognize that various changes and modifications of the embodiments described herein can be made without departing from the scope of invention. In addition, descriptions of well-known functions and constructions are omitted for clarity and conciseness.

Features that are described and/or illustrated with respect to one embodiment may be used in the same way or in a similar way in one or more other embodiments and/or in combination with or instead of the features of the other embodiments.

The terms and words used in the following description are not limited to the bibliographical meanings, but, are merely used to enable a clear and consistent understanding of the invention. Accordingly, it should be apparent to those skilled in the art that the following description of exemplary embodiments of the present invention are provided for illustrative purpose only and not for the purpose of limiting the invention.

It is to be understood that the singular forms “a”, “an” and “the” include plural referents unless the context clearly dictates otherwise.

It should be emphasized that the term “comprises/comprising” when used in this specification is taken to specify the presence of stated features, integers, steps or components but does not preclude the presence or addition of one or more other features, integers, steps, components or groups thereof. The equations used in the specification are only for computation purpose.

Accordingly, the present invention relates to a gel based formulation for enhancing shelf life of agricultural products and a method for preparation thereof. More particularly, the present invention relates to a gel based formulation inducing the production of nitric oxide gas which inhibits ethylene production, enhancing defense responses and ultimately results in enhancing shelf life of agricultural products such as fruits and vegetables and prevents spoilage thereof.

In an embodiment, the present invention relates to a gel based formulation to enhance shelf life of agricultural products by natural route comprising: one or more natural source of ascorbate in a range of 0.16-0.3% by weight of the total composition; one or more source of acetic acid in a range of 3-5% by weight of the total composition; one or more natural source of nitrate grown hydrophonic plants in a range of 1-5% by weight of the total composition; at least one source of natural salicylic acid in a range of 0.1-1% by weight of the total composition; at least one solidifying agent in a range of 0.4-2% by weight of the total composition and at least one pharmaceutically acceptable excipient.

In an embodiment, the one or more source of ascorbate is in a range of 0.1 to 1.8 mM in concentration.

In an embodiment, the natural source of ascorbate is peels of citrus fruits selected from a group of fruits consisting of peels of oranges, lemon, elementin, mandarin orange, and pomilo or a combination thereof.

In an embodiment, the source of acetic acid is a vinegar selected from a group consisting of apple cider vinegar, white vinegar, rice vinegar or combination thereof.

In an embodiment, the excipient is selected from the stabilizers such as but not limited to sodium alginate, potassium alginate, calcium alginate and ammonium alginate.

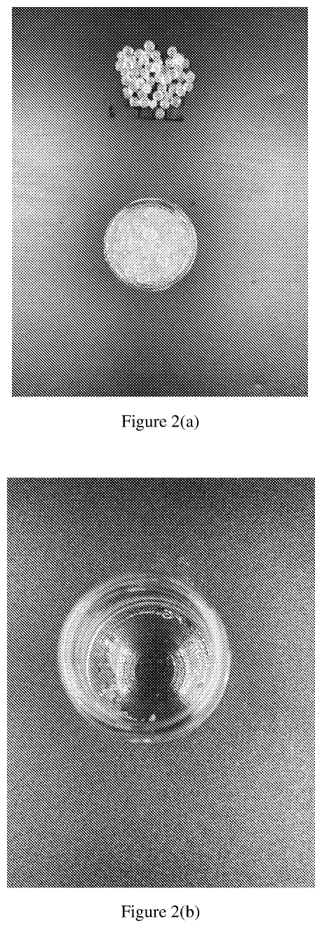

In an embodiment, as shown in FIG. 3, the method for preparing gel based formulation is based on a natural route which results in the preparation of organic gel based formulation. The method employs the use of peels of fresh citrus fruits serving as a natural source of ascorbate. The method comprises of the following steps:
a) drying peels of citrus fruits in a dryer at 70-72 °C for at least 3 days;
b) grounding the peels into fine powder;
c) treating plants of nitrate grown, cereals under red light/dark and 0.1 to 4% oxygen under dark for 12-18 hours;
d) drying at 60-70 °C for 24 hours and grounding to fine powder in the presence of 0-5% citrus peel powder;
e) adding 0.4to −2% gelling/solidfying agent in 200-250 ml distilled water;
f) heating the solution prepared in step (c) for 1-2 minutes;
g) adding 0.1-5% of powder of citrus fruits prepared in step (e);
h) adding 3-5% of vinegar to the solution obtained in step (f);
j) adding 1-2% of an acidified cumin powder to the solution obtained in step (h), forming gel based formulation.

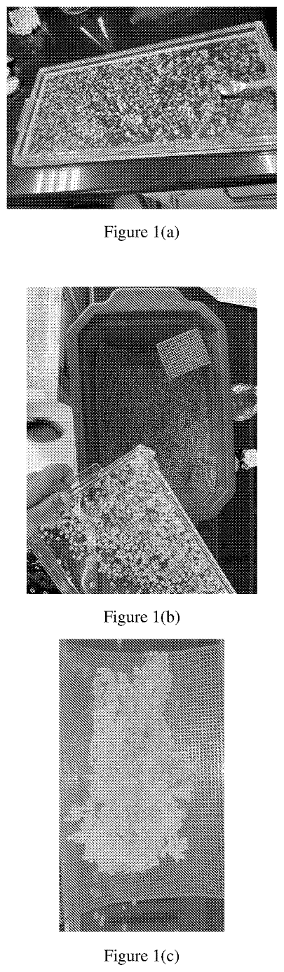

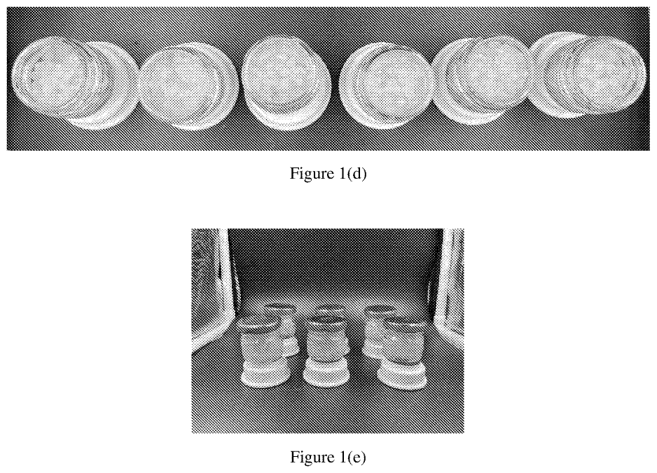

In an alternate embodiment, as shown in FIG. 1(a-e) and FIG. 2, the gel based formulation of the present invention may also be prepared through a synthetic route. The method results in formation of bead like structures of alginates containing core of cereal powder and the acidified cumin powder which remains in constant touch with citric peel alginate complex, resulting in slow release of nitric oxide. The method comprises of the following steps:
a) preparing 1.5-2% solution of sodium alginate by dissolving sodium alginate in water under constant stirring;
b) adding citrus peel powder to the solution prepared in step (b) such that the molar ratio of citrus peel powder to sodium alginate solution is in a range of 2.5:1.5 to 3-2;
d) adding 3 mM-4 mM of calcium chloride in the solution prepared in step (c); and e) adding the solution prepared in step (b) to the solution prepared in step (d), resulting in encapsulation of low oxygen treated nitrate rich cereal powder and acidic jeera powder with alginate and citrus peel solution as outer layer.

In an embodiment, the peels of citrus fruits used in the present invention may include such as, but not limited to, peels of oranges, lemon, elementin, mandarin orange, Pomilo and the like.

In an embodiment, the gelling agent may include such as, but not limited to, agar, phytagel, gel extracted from Salvia sclarea, and the like.

In an embodiment, the heating of the solution may be performed in an oven, or microwave for 1-2 minutes.

In an embodiment, the vinegar used may be selected from a group consisting of, such as, but not limited to, apple cider vinegar, white vinegar, rice vinegar or combination thereof.

In an embodiment, the nitrate grown hydrophonic plants may be selected from a group consisting of, such as, but not limited to, rice plants, wheat plants, maize plants, corn plants or combination thereof.

In another embodiment, the gel based formulation prepared in the present invention is kept in a container inside a closed box containing agricultural products such as, but not limited to, fruits and vegetables. In an exemplary embodiment, the container may be selected from such as, but not limited to, glass vials, beakers, etc. The gel based formulation generates nitric oxide in gas phase and creates a modified atmosphere around the agricultural products kept inside the box. The generated nitric oxide inhibits ethylene production and ultimately enhances the shelf life of the agricultural products kept inside the box.

In another embodiment, the defense responses are boosted by via salicylic acid mediated pathway.

The present invention exhibits the following advantages:
a) The present invention provides an effective gel based formulation that induces the production of nitric oxide which ultimately increases the shelf life of agricultural products.
b) The gel based formulation prepared in the present invention actively works in wide range of temperatures ranging from 2 to 45 °C and therefore adaptable in wide range of storage conditions.
c) The gel based formulation prepared in the present invention helps in boosting of defense response of fruits and vegetables.

The following experimental data should not be construed to limit the scope of the invention.

### EXPERIMENTAL DATA

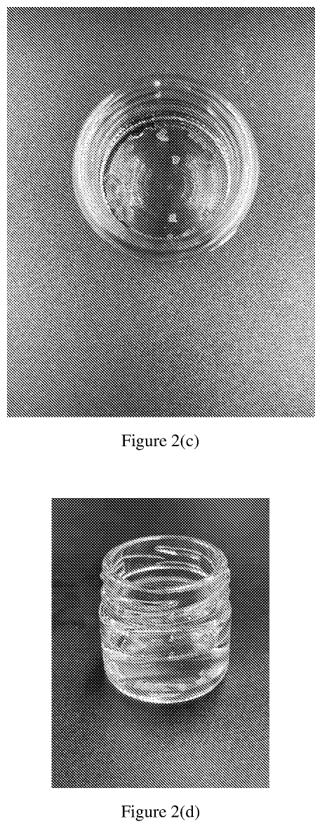

As shown in FIG. 4, the gel based formulations prepared in the present invention were tested for the generation of nitric oxide. The test was performed separately to evaluate the nitric oxide generation ability of both the gel based formulations prepared through natural route. The gel based formulations were placed in a beaker The release of nitric oxide from the gel based formulations was detected by any known nitrate oxide detection/assay methods such as but not limited to griess reaction method (using griess reagent assay), fluorescent probes, EPR, chemiluminescence, oxyhaemoglobin (Hb-Ch) assay, laser photoacoustics, membrane inlet-mass spectrometry, and amperometric methods with NO-specific electrodes.

Several experiments were performed to test the effectiveness of the gel based formulations prepared in the present invention towards enhancing post-harvest shelf life of various fruits such as mangoes, blueberry, and banana.

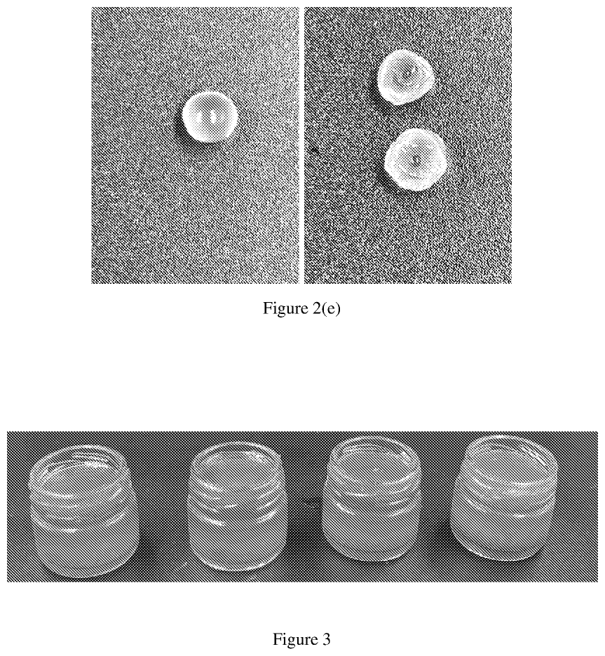

As shown in FIG. 5, the effect of gel based formulation prepared through natural route on shelf life of Alphanso mangoes was reported for 12 days. Two sets of Alphanso mangoes were prepared, one set was control set wherein the Alphanso mangoes were kept inside a box without gel based formulation and another was test set wherein the Alphanso mangoes were kept inside a box containing gel based formulation in a glass vial. The glass vial containing gel based formulation inside the box was placed near Alphanso mangoes. Each set contained 5 Alphanso mangoes. At Day 0, both the control set and test set were fresh in its natural form i.e. without any spoilage. At Day 5, approximately 4.5% of Alphanso mangoes in control set were spoiled. However, the test set of Alphanso mangoes were in its fresh form i.e. without any spoilage. At Day 10, approximately 15% of Alphanso mangoes in control set were spoiled. However, approximately 3.6% of Alphanso mangoes of the test set showed spoilage. At Day 12, 28% of Alphanso mangoes in control set were spoiled. However, only 4% of Alphanso mangoes of test set showed spoilage.

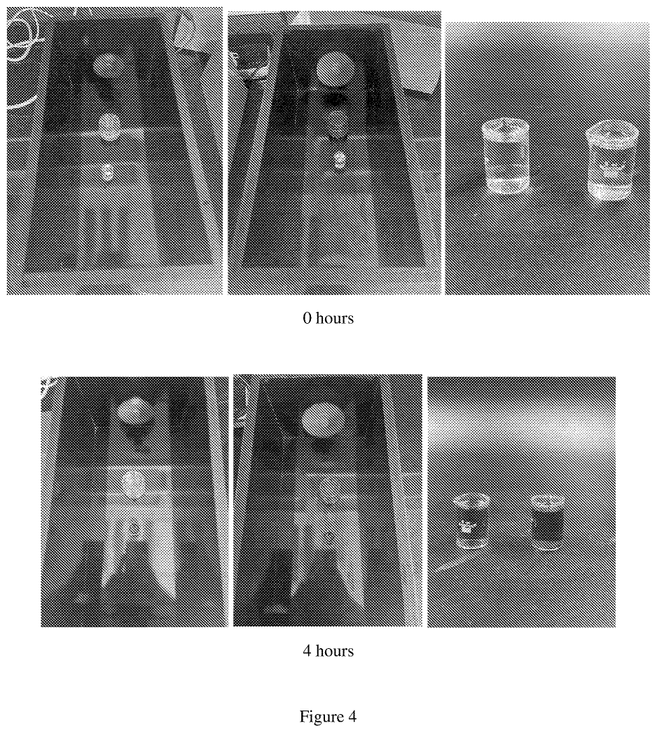

As shown in FIG. 6, the effect of gel based formulation prepared through natural route on shelf life of Dinga mangoes was reported for 14 days. Two sets Dinga mangoes were prepared, one set was control set wherein Dinga mangoes were kept inside a box without gel based formulation and another set was test set wherein Dinga mangoes were kept inside a box containing gel based formulation in a glass vial The glass vial containing gel based formulation inside the box was placed near Dinga mangoes. The control set contained 12 Dinga mangoes and the test set contained 11 Dinga mangoes. At Day 0, Dinga mangoes in both control set and test set were fresh in its natural form i.e. without any spoilage. At Day 3, 1 out of 12 Dinga mangoes of control set showed spoilage to an extent. However, Dinga mangoes of test set were in its fresh state i.e. without any spoilage. At Day 7, 1 out of 12 Dinga mangoes of control set were spoiled. However, Dinga mangoes of test set were in its fresh state i.e. without any spoilage. At Day 9, almost 2 out of 12 Dinga mangoes of control set were spoiled. However, Dinga mangoes of test set were in its fresh state i.e. without any spoilage. At Day 14, 85% of the Dinga mangoes of control set were spoiled whereas only 30% of the Dinga Mangoes of the test set showed spoilage.

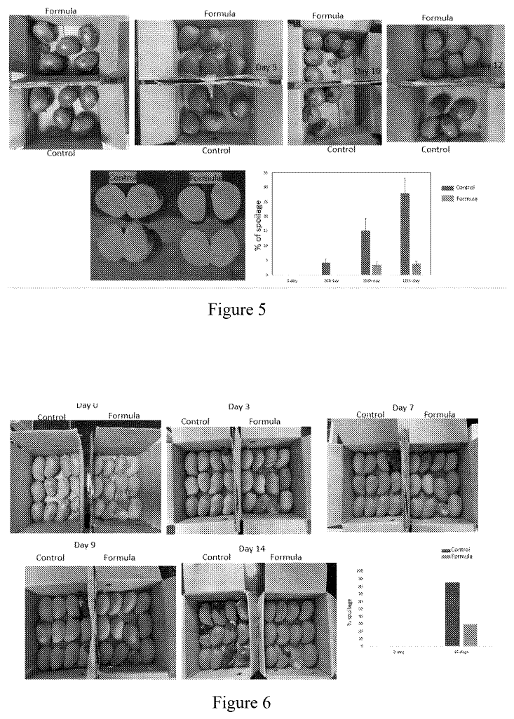

As shown in FIG. 7, the effect of gel based formulation prepared through natural route on shelf life of Ritol mangoes was reported for 12 days. Two sets of Ritol mangoes were prepared, one set was control set wherein the Ritol mangoes were kept inside a box without any gel based formulation and another set was test set wherein the Ritol mangoes were kept inside a box containing gel based formulation in a glass vial. The glass vial containing gel based formulation inside the box was placed near Ritol mangoes. Each set contained 9 Ritol mangoes. At Day 0, both the control set and test set were fresh in its natural form i.e. without any spoilage. At Day 3, 2 out of 9 ritol mangoes of control set were spoiled. However, Ritol mangoes of test set were in its fresh state i.e. without any spoilage. At Day 7, 4 out of 9 Ritol mangoes of control set were spoiled. However, Ritol mangoes of test set were in its fresh state i.e. without any spoilage. At Day 12, 5 out of 9 Ritol mangoes of the control set were spoiled whereas onlyl out of 9 Ritol mangoes of the test set were spoiled.

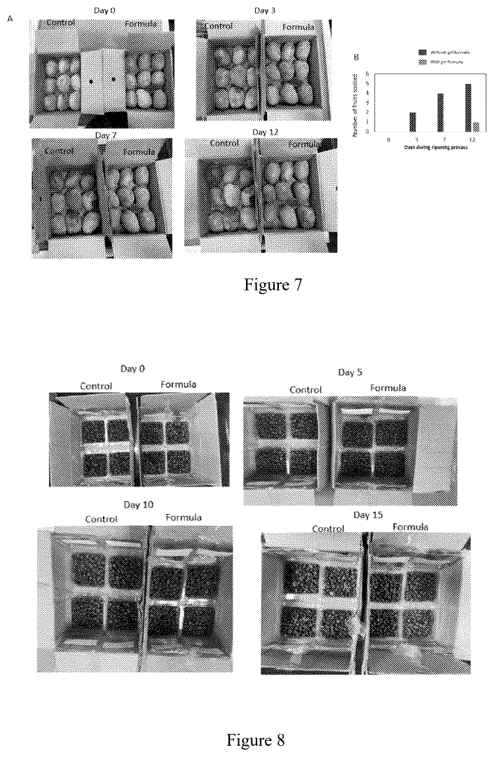

As shown in FIG. 8, the effect of gel based formulation prepared through natural route on the shelf life of blueberry was evaluated. Two sets of blueberries were prepared, one set was control set wherein the blueberries were kept inside a box without any gel based formulation and another set was test set wherein the blueberries were kept inside a box containing gel based formulation in a glass vial. The glass vial containing gel based formulation inside the box was placed near Blueberries. At Day 0, the blueberries in both control set and test set were fresh in its natural form i.e. without any spoilage. At Day 5, the blueberries of control set started to spoil whereas the blueberries of the test set were still fresh. At Day 10, the blueberries of control set showed spoilage to a greater extent and the blueberries of test set were fresh i.e. without any spoilage. At Day 15, the blueberries of test set showed enhanced shelf life in form of freshness as compared to the control set in which the blueberries were completely spoiled.

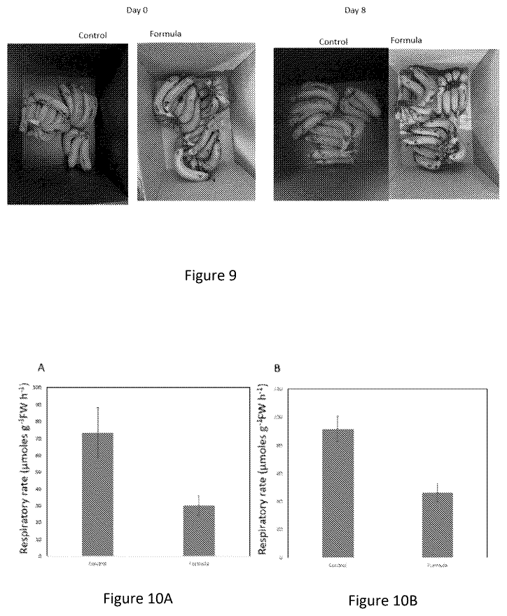

As shown in FIG. 9, the effect of gel based formulation prepared through natural route on the shelf life of banana was evaluated. Two sets of bananas were prepared, one set was control set wherein the bananas were kept inside a box without any gel based formulation and another set was test set wherein the bananas were kept inside a box containing gel based formulation in a glass vial. The glass vial containing gel based formulation inside the box was placed near Bananas. At Day 0, the bananas in both control set and test set were fresh in its natural form i.e. fresh, without any spoilage. At Day 8, the bananas of test set showed enhanced shelf life in form of freshness as compared to the control set in which the bananas were spoiled to a greater extent.

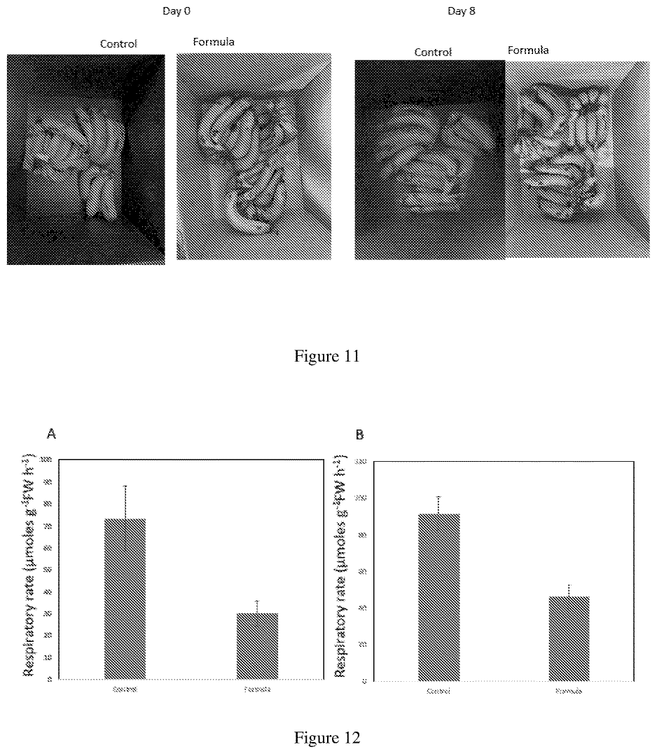

As shown in FIG. 10 A, the graph represents effect of gel based formulation on the respiratory oxygen consumption rate (respiratory rate) evaluated on Custard Apple for 3 days of ripening. Two sets of Custard Apples were prepared, one set was control set, wherein Custard Apple were kept inside a box without any gel based formulation and another set was test set, wherein Custard Apples were kept inside a box containing gel based formulation in a glass vial. At Day 0, the Custard Apples in both control set and test set were fresh in its natural form i.e. without any spoilage. The respiratory rate of the Custard Apple in both control set and test set were measured. At Day 3, it has been seen that the custard apple in test set showed decrease in respiratory rate as compared to the control set.

As shown in FIG. 10 B, the graph represents effect of gel based formulation on the respiratory oxygen consumption rate (respiratory rate) evaluated in Bananas for 3 days of ripening. Two sets of bananas were prepared, one set was control set, wherein Bananas were kept inside a box without any gel based formulation and another set was test set, wherein bananas were kept inside a box containing gel based formulation in a glass vial. At Day 0, the Bananas in both control set and test set were fresh in its natural form i.e. without any spoilage. The respiratory rate of the Bananas in both control set and test set were measured. At Day 3, it has been seen that the Banana in test set showed decrease in respiratory rate as compared to the control set.

While the present invention has been described with reference to one or more preferred aspects, which aspects have been set forth in considerable detail for the purposes of making a complete disclosure of the invention, such aspects are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the principles of the invention.

1. A gel based formulation to enhance shelf life of agricultural products by natural route comprising:
one or more natural plant based source of ascorbate in a range of 0.1-5% by weight of the total composition;
one or more source of acetic acid in a range of 3-5% by weight of the total composition;
one or more source of nitrates grown hydroponic plants in a range of 1-5% by weight of the total composition;
at least one source of natural salicylic acid in a range of 0.1-0.5% by weight of the total composition;
at least one solidifying agent in a range of 0.4-2% by weight of the total composition; and at least one pharmaceutically acceptable excipient.

2. The gel based composition as claimed in claim 1, wherein the source of ascorbate is peels of citrus fruits selected from a group of fruits consisting of peels of oranges, lemon, elementin, mandarin orange, and pomilo or a combination thereof.

3. The gel based composition as claimed in claim 1, wherein the source of acetic acid is a vinegar selected from a group consisting of apple cider vinegar, white vinegar, rice vinegar or combination thereof.

4. The gel based composition as claimed in claim 1, wherein the solidifying agent is selected from a group consisting of agar, phytagel, or a gel extracted from Salvia sclarea.

5. The gel based composition as claimed in claim 1, wherein the hydrophonically grown nitrate grown plants are selected from a group of cereal crops consisting of rice, wheat, maize, corn or combination thereof.

6. The gel based composition as claimed in claim 1, wherein the excipients are stabilizers selected from the group of sodium alginate, potassium alginate, calcium alginate and ammonium alginate.

7. A method for preparing a gel based formulation as claimed in claim 1 by using natural route, wherein the method comprising the steps of:
a) drying peels of citrus fruits in a dryer at 70-72 °C for at least 3 days;
b) grounding the peels into fine powder;
c) treating whole nitrate grown hydroponic plants with oxygen concentration 0.5% to 4% under dark and red light cycles for 12-18 hours at 18-20 C, subsequent drying at 60-70 °C for 24 hours and grounding to fine powder in the presence of 0.-5% citrus peel powder
d) adding 1.5-2% solidifying agent in 200-250 ml of distilled water;
e) heating the solution prepared in step (d) for 1-2 minutes;
f) adding 0.15% of powder of citrus fruits prepared in step (e);
g) adding 3-5% of vinegar to the solution obtained in step (f);
h) forming the gel based formulation by adding 0.5-8% of acidified cumin powder to the solution obtained in step (g).

8. The method as claimed in claim 7, wherein the peels of citrus fruits are selected from a group of fruits consisting of peels of oranges, lemon, elementin, mandarin orange, and pomilo or a combination thereof.

9. The method as claimed in claim 7, wherein the vinegar is selected from a group consisting of apple cider vinegar, white vinegar, rice vinegar or combination thereof.

10. The method as claimed in claim 7, wherein the solidifying agent is selected from a group consisting of agar, phytagel, or a gel extracted from Salvia sclarea.

11. A method for preparing a gel based formulation as claimed in claim 1-6 by using synthetic route, comprising the steps of:
a) preparing 1.5-2% solution of sodium alginate by dissolving sodium alginate in water under constant stirring;
b) adding citrus peel powder to the solution in the molar ratio of citrus peel powder to sodium alginate solution in a range of 2.5:1.5 to 3-2 ; and
c) encapsulating low oxygen treated nitrate rich cereal powder and acidic cumin (jeera) powder with alginate and citrus peel solution by adding 3 mM-4 mM of calcium chloride in the solution obtained in step (b).

12. The method as claimed in claim 9, wherein the peels of citrus fruits are selected from a group of fruits consisting of peels of oranges, lemon, elementin, mandarin orange, and pomilo or a combination thereof.

13. The method as claimed in claim 9, wherein the excipients are stabilizers selected from the group of sodium alginate, potassium alginate, calcium alginate and ammonium alginate.
